(19) United States
(12) Patent Application Publication
(10) Pub. No.: US 2004/0193659 A1
(43) Pub. Date: Sep. 30, 2004

(54) Method, apparatus, and program for archive management based on access log

(75) Inventors: Michael Pierre Carlson, Austin, TX (US); Srinivas Chowdhury, Temple, TX (US)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY (US)

(21) Appl. No.: 10/401,331

(22) Filed: Mar. 27, 2003

(51) Int. Cl. G06F 17/30; G06F 12/00

(52) U.S. Cl. 707/204

(57) ABSTRACT

An archive mechanism automatically archives or unarchives content files based upon how frequently or recently a file is accessed. A content manager keeps an access log and generates access statistics from the access log. When inspecting content for files to be archived, the archive mechanism identifies files that were least frequently and/or least recently accessed. These files are then compressed into one or more archive files and moved to archive storage. The archive mechanism may also identify archived files that are frequently and/or recently accessed. These files are candidates for unarchiving. The content manager may also indicate whether a content file is archived in an archive lookup table. The archive lookup table may also include reference to the archive file. When a request is received for an archived file, the archive mechanism retrieves the archive file and decompresses the archive file. The content manager extracts the content file from the archive file and returns the requested file to the user. If the file is frequently accessed, the content manager may call the archive mechanism to unarchive the file.

### BACKGROUND OF THE INVENTION

1. Technical Field

The present invention relates to content management and, in particular, to archive management. Still more particularly, the present invention provides a method, apparatus, and program for archive management based on access statistics.

2. Description of Related Art

The management of an organization's Web content is a daunting task. The required volume of new content grows rapidly, while the pressure to keep the costs dedicated for storage, transfer, and maintenance low increases. Several content management applications are available for managing content and meta-data.

In most cases, content is stored on hard disk as individual files in some predetermined directory structure. As the volume of the content grows, the disk space required to store the content increases, thus increasing the cost of storage, backup, etc. Consider as an example an online newspaper. Each day a new edition of the newspaper is published and, thus, a large amount of content is added. Often times, it is desirable to keep old editions available. However, as the content becomes older, the chances of that content being accessed become lower, even though the old content is taking up as much storage space as the new content.

Archive systems may move data onto a secondary disk or tape for backup or data retention purposes. Archived files are normally compressed to maximize storage media. Known archive systems use only timestamps or inputted file names to determine content to be archived. Some files with older timestamps may be archived despite the fact that they are frequently accessed. In the meantime, some newer files may remain in content storage, even though they are accessed very infrequently.

When a request for archived content is received, the file manager may return a message that the content is no longer available. Some file management systems may return the compressed archive file to the requesting user, who must then decompress the archive file and locate the content file in order to access the desired content. This requires an additional piece of software to be installed and managed on the end user's computer as well as requiring the compression algorithm to be known and available on the user's computer. Some Web browsers may decompress content. However, in many current implementations, this content is compressed by the Web server, which increases the workload of the server.

Therefore, it would be advantageous to provide an improved mechanism for archiving content and for providing access to archived content.

### SUMMARY OF THE INVENTION

The present invention provides an archive mechanism in which content files are automatically archived or unarchived based upon how frequently or recently a file is accessed. A content manager keeps an access log and generates access statistics from the access log. When inspecting content for files to be archived, the archive mechanism identifies files that were least frequently and/or least recently accessed. These files are then compressed into one or more archive files and moved to archive storage. The archive mechanism may also identify archived files that are frequently and/or recently accessed. These files are candidates for unarchiving.

The content manager may also indicate whether a content file is archived in an archive lookup table. The archive lookup table may also include reference to the archive file. When a request is received for an archived file, the archive mechanism retrieves the archive file and decompresses the archive file. The content manager extracts the content file from the archive file and returns the requested file to the user. If the file is frequently accessed, the content manager may call the archive mechanism to unarchive the file.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram illustrating a content manager in accordance with a preferred embodiment of the present invention;

FIG. 5 depicts an example archive lookup table in accordance with a preferred embodiment of the present invention;

FIG. 6 is a flowchart illustrating the operation of an archive mechanism in accordance with a preferred embodiment of the present invention; and

FIG. 7 is a flowchart illustrating the operation of a content manager in accordance with a preferred embodiment of the present invention.

### DETAILED DESCRIPTION OF THE PREFERRED EMBODIMENT

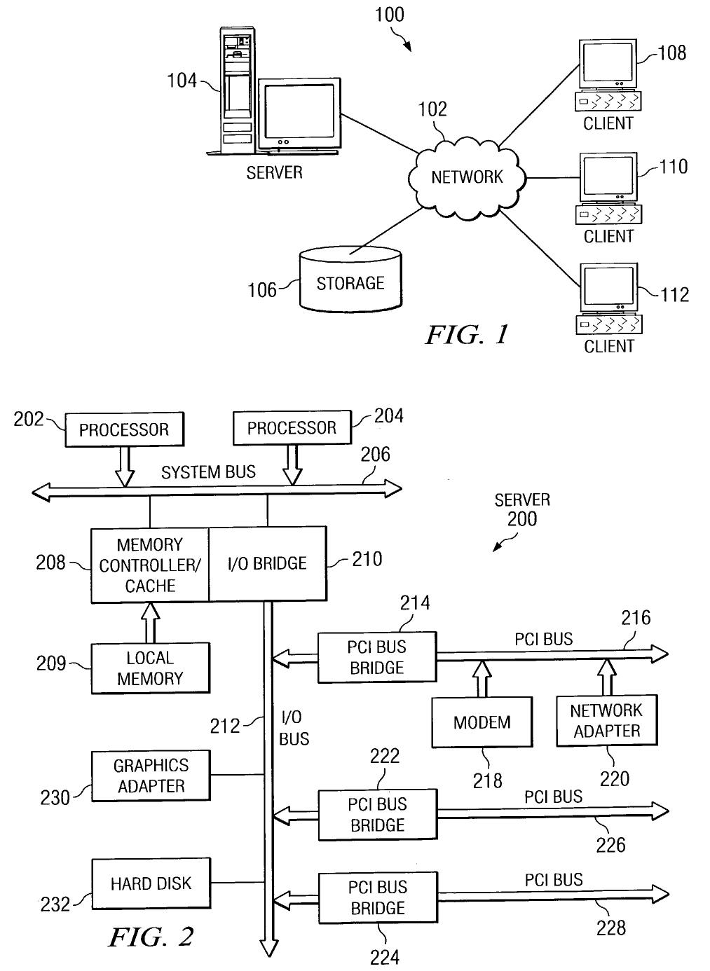

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

Server 104 may be a Web server and storage 106 may store Web content. In accordance with a preferred embodiment of the present invention, the server includes a content manager with an archive mechanism in which content files are automatically archived or unarchived based upon how frequently or recently a file is accessed. The content manager keeps an access log and generates access statistics from the access log. When inspecting content for files to be archived, the archive mechanism identifies files that were least frequently and/or least recently accessed. These files are then compressed into one or more archive files and moved to archive storage. The archive mechanism may also identify archived files that are frequently and/or recently accessed. These files are candidates for unarchiving.

The content manager may also indicate whether a content file is archived in an archive lookup table. The archive lookup table may also include reference to the archive file. When a request is received for an archived file, the archive mechanism retrieves the archive file and decompresses the archive file. The content manager extracts the content file from the archive file and the server returns the requested file to the client. If the file is frequently accessed, the content manager may call the archive mechanism to unarchive the file.

In the depicted example, network data processing system 100 may be the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pseries system, a product of International Business Machines Corporation in Armonk, N.Y., running the Advanced Interactive Executive (AIX) operating system or LINUX operating system.

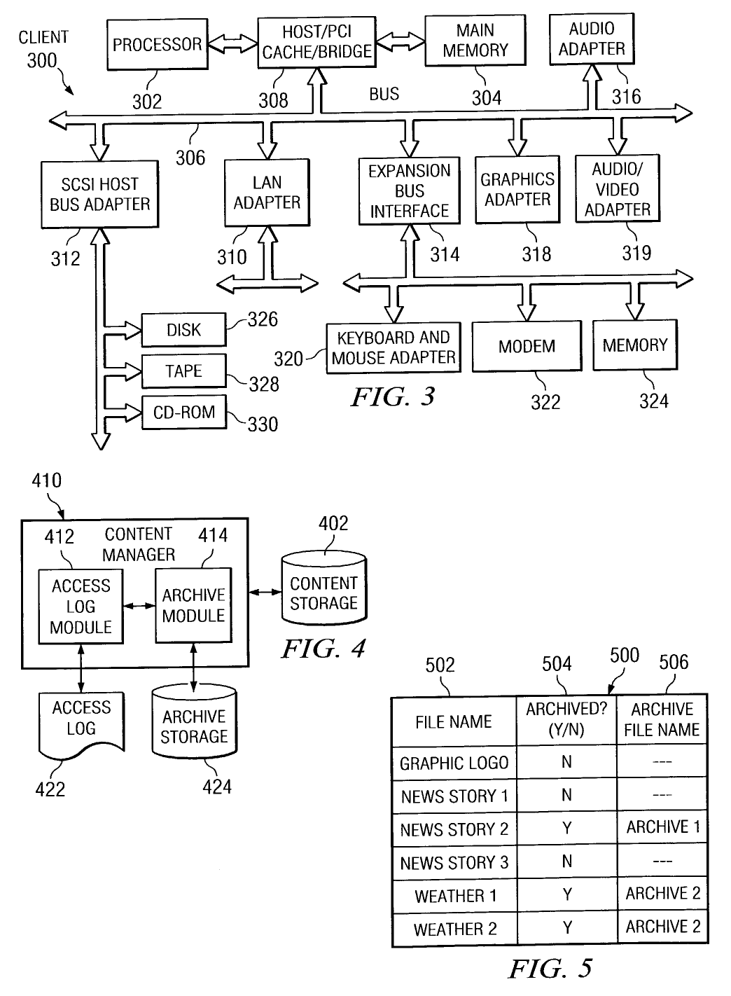

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With reference to FIG. 4, a block diagram illustrating a content manager is shown in accordance with a preferred embodiment of the present invention. Content manager 410 manages content in content storage 402. Content files may be added, deleted, updated, or modified using content manager 410. Content storage 402 may be persistent storage, such as hard disk or magnetic tape storage. In a preferred embodiment, content storage 402 comprises one or more hard disk drives.

In accordance with the present invention, Content manager 410 includes access log module 412 and archive module 414. Access log module 412 stores access information in access log 422. The access log records access requests for content files. Access requests may be requests to read, write, update, or modify content files. From the access log, access log module 412 can compile access statistics. The access log module can then identify files that are accessed infrequently and/or content files that are least recently accessed.

Archive module 414 identifies candidate files in content storage 402 and moves these files to archive storage 424, which may be a set of secondary disk drives or magnetic tape drives. Preferably, files are compressed into an compressed archive file, such as a Java ARchive (JAR) file or a ZIP file. The JAR file format is a compression format used for compressing Java programs and objects. A ZIP file may be created using PKZIP from PKWARE, Inc. However, the ZIP file format is a very popular file compression format and ZIP and UNZIP utilities have been placed in the public domain.

In accordance with a preferred embodiment of the present invention, archive module 414 automatically archives or unarchives content files based upon how frequently or recently a file is accessed. The archive module of the present invention identifies files that were least frequently and/or least recently accessed based upon access statistics from access log module 412. These files are then compressed into one or more archive files and moved to archive storage. The archive module may also identify archived files that are frequently and/or recently accessed based upon access statistics from access log module 412. These files are candidates for unarchiving.

Frequency of infrequency may be determined based upon the number of times a file is accessed during a specific time period. For example, the archive module may decide that a file is a candidate for archival if the file is accessed less than a threshold number of times in the last day or week. As another example, the archive module may decide that an archived file is a candidate for unarchiving if the file is accessed more than a threshold number of times in the last hour, day, or week.

The content manager may also indicate whether a content file is archived in an archive lookup table, which will be described below with reference to FIG. 5. The archive lookup table may also include reference to the archive file in archive storage 424. When a request is received for an archived file, the archive module may retrieve the archive file and decompresses the archive file. The content manager may then extract the content file from the decompressed archive file and return the requested file to the user. If the file is frequently accessed, the content manager may call archive module 414 to unarchive the file.

Content manager 410 may be embodied within a Web server, such as server 104 in FIG. 1, or other device that provides a large amount of content. For example, content manager 410 may be integrated within an electronic mail program, User Network (USENET) news client, message board server, or the like. The content manager may also be integrated within an operating system or file manager. Thus, an operating system or file manager incorporating the content manager of the present invention may make more efficient use of hard drive space by archiving files that are accessed infrequently. The content manager may then archive files to a portion of the hard drive, such as an archive partition, or to a secondary drive.

Other modifications may be made to content manager 410 within the scope of the present invention. For example, content manager 410, access log module 412, and archive module 414 may be implemented on the same computer or on different computers working in cooperation with one another. FIG. 4 is intended as an example, and not as an architectural limitation for the present invention.

With reference now to FIG. 5, an example archive lookup table is illustrated in accordance with a preferred embodiment of the present invention. Archive lookup table 500 stores archive information for content files. The table includes the file name 502 and an indication as to whether the file is archived 504. The indication as to whether a file is archived may be a single bit or “flag.” Alternatively, indication 504 may a Boolean variable with a “true” or “false” value. Indication 504 may also be expressed with a “yes” or “no” value.

The archive lookup table may also include an archive file name 506 if the file is archived. In the depicted example, the file named “Graphic Logo” is not archived; therefore, there is no archive file name indicated in 506. However, the file named “News Story 2” is archived in the archive file named “Archive 1.” Also, both content files “Weather 1” and “Weather 2” are archived in the archive file named “Archive 2,” as indicated in 506.

Whenever the archive module archives a content file, archive lookup table 500 is updated. The archive module updated indication 504 and stores the archive file name in column 506. In addition, when the archive module unarchives a content file, the archive lookup table must be updated. If the archive module unarchives an entire archive file, then all content files in the archive file must be updated. On the other hand, the archive module may extract the content file and re-compress the remaining files into an archive file of the same or a different name. In this case, the archive lookup table must be updated to reflect the unarchived file. If the remaining files are compressed into an archive file of a different name, then archive file name 506 must be updated for those remaining files.

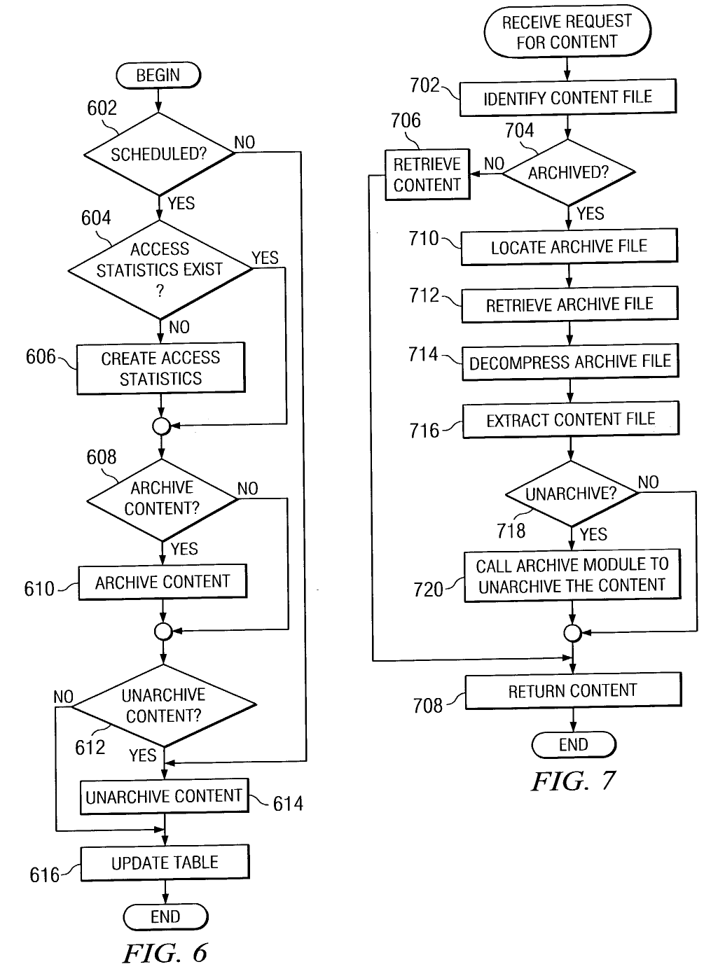

FIG. 6 is a flowchart illustrating the operation of an archive mechanism in accordance with a preferred embodiment of the present invention. The process begins and a determination is made as to whether an archive is scheduled (step 602). The archive process may be started by a scheduler. The archive process may also be scheduled to take place in response to a particular event, such as exiting an electronic mail program. However, the archive process may also he triggered by an external process. This external process may be a process that looks at access stats and determines that a specific content file is accessed a predetermined number of times during a specific duration.

If the archive process is scheduled, a determination is made as to whether access statistics exist (step 604). If access statistics do not exist, the process creates access statistics (step 606) and a determination is made as to whether candidate files for archival are identified (step 608). If access statistics exist in step 604, the process continues directly to step 608 to determine whether content files are to be archived.

If files are to be archived, the process archives the content (step 610) and a determination is made as to whether candidate files for unarchiving exist (step 612). In a preferred embodiment, content files are archived by compressing them into an archive file and storing the archive file in archive storage. The archived files may then be removed from content storage to create space for new content. If no candidate files for archival are identified in step 608, the process continues directly to step 612 to determine whether files are to be unarchived.

If files are to be unarchived, the process unarchives the content (step 614) and updates the archive lookup table (step 616). In a preferred embodiment, content files are unarchived by locating and decompressing the archive file and then extracting the content files. The content files may then be restored to content storage. If no candidate files for unarchiving are identified in step 612, the process continues directly to step 616 to update the archive lookup table. Thereafter, the process ends.

Returning to step 602, if the archive process is not scheduled, the process advances to step 614 to unarchive specified content files. Then, the process updates the archive lookup table (step 616) and ends.

Turning now to FIG. 7, a flowchart illustrating the operation of a content manager is shown in accordance with a preferred embodiment of the present invention. The process begins by receiving a request for content. Then, the process identifies a requested content file (step 702). The content file may be identified, for example, in a uniform resource locator (URL) or other convention, such as a directory path and file name.

Next, a determination is made as to whether the content file is archived (step 704). If the content file is not archived, the process retrieves the content (step 706) and returns the content (step 708). Thereafter, the process ends.

If the content file is archived in step 704, the process locates the archive file (step 710), retrieves the archive file (step 712), and decompresses the archive file (step 714). The process then extracts the content file from the archive (step 716).

Then, a determination is made as to whether to unarchive the file (step 718). This determination is made based on access statistics or an access log. If the content file is accessed frequently, particularly during a predetermined period of time, the process identifies this file as a candidate for unarchiving. If the file is to be unarchived, the process calls the archive module to unarchive the content (step 720), returns the content (step 708), and ends. However, if the file is not a candidate for unarchiving in step 718, the process advances to step 708 to return the content. Thereafter, the process ends. If at any time during the process illustrated in FIG. 7 an error occurs, the process my return an error message.

Thus, the present invention solves the disadvantages of the prior art by automatically archiving content depending on frequency of access. The archive mechanism of the present invention determines how content is accessed by analyzing access logs or available access statistics. The archive mechanism may be scheduled or run on demand. Using available access log or access statistics and files in content storage, the archive mechanism may identify candidate files for archiving or unarchiving to make most efficient use of content storage space.

Furthermore, the archive mechanism of the present invention makes archived files available for access. If a request is received for an archived file, the archive mechanism may retrieve and decompress the archive file to extract the requested file. Furthermore, if archived files are suddenly accessed frequently, these files may be unarchived and restored in content storage.

The present invention makes more efficient use of storage space. The archive is easily maintained, yet adaptable to changing access trends. In addition, if an organization has outsourced the infrastructure for improved end user experience, then the centralized contents may be archived. Thus, files that are used regularly, but not changed often, such as company logos and the like, can be archived.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for archive management, the method comprising:
identifying one or more content files in content storage that are candidates for archiving based on access information;
archiving the one or more content files into archive storage.

2. The method of claim 1, wherein the step of identifying one or more content files in content storage that are candidates for archiving based on access information includes:
identifying at least one candidate file that is a least frequently accessed file in content storage.

3. The method of claim 1, wherein the step of identifying one or more content files in content storage that are candidates for archiving based on access information includes:
identifying at least one candidate file that is accessed less than a predetermined number of times during a specific duration.

4. The method of claim 1, wherein the access information includes one of an access log and access statistics.

5. The method of claim 1, wherein the step of archiving the one or more content files includes:
compressing the one or more content files into an archive file;
storing the archive file in archive storage; and
removing the one or more content files from content storage.

6. The method of claim 5, further comprising:
receiving a request for a requested file within the one or more content files;
identifying the archive file;
extracting the requested file from the archive file; and
returning the requested file.

7. The method of claim 6, further comprising:
determining whether the requested tile in archive storage is a candidate for unarchiving based on access information;
unarchiving the requested file from archive storage; and
restoring the requested file to content storage.

8. The method of claim 1, further comprising:
identifying one or more archived files in archive storage that are candidates for unarchiving based on access information;
unarchiving the one or more archived files from archive storage; and
restoring the one or more archived files to content storage.

9. A method for archive management, the method comprising:
receiving a request for a requested file, wherein the requested file is archived within an archive file in archive storage;
identifying the archive file;
extracting the requested file from the archive file; and
returning the requested file.

10. The method of claim 9, further comprising:
determining whether the requested file is a candidate for unarchiving based on access information;
unarchiving the requested file; and
restoring the requested file to content storage.

11. The method of claim 9, wherein the step of determining whether the requested file is a candidate for unarchiving based on access information includes:
identifying at least one candidate file that is a most frequently accessed file in archive storage.

12. The method of claim 9, wherein the step of determining whether the requested file is a candidate for unarchiving based on access information includes:
identifying at least one candidate file that is accessed more than a predetermined number of times during a specific duration.

13. A method for archive management, the method comprising:
identifying one or more archived files in archive storage that are candidates for unarchiving based on access information;
unarchiving the one or more archived files from archive storage; and
restoring the one or more archived files to content storage.

14. The method of claim 13, wherein the step of identifying one or more archived files in archive storage that are candidates for unarchiving based on access information includes:
identifying at least one candidate file that is a most frequently accessed file in archive storage.

15. The method of claim 13, wherein the step of identifying one or more archived files in archive storage that are candidates for unarchiving based on access information includes:
identifying at least one candidate file that is accessed more than a predetermined number of times during a specific duration.

16. An apparatus for archive management, the apparatus comprising:
identification means for identifying one or more content files in content storage that are candidates for archiving based on access information;
archiving means for archiving the one or more content files into archive storage.

17. The apparatus of claim 16, wherein the identification means includes:
means for identifying at least one candidate file that is a least frequently accessed file in content storage.

18. The apparatus of claim 16, wherein identification means includes:
means for identifying at least one candidate file that is accessed less than a predetermined number of times during a specific duration.

19. The apparatus of claim 16, wherein the access information includes one of an access log and access statistics.

20. The apparatus of claim 16, wherein the archiving means includes:
compression means for compressing the one or more content files into an archive file;
storage means for storing the archive file in archive storage; and
removal means for removing the one or more content files from content storage.

21. The apparatus of claim 20, further comprising:
means for receiving a request for a requested file within the one or more content files;
means for identifying the archive file;
means for extracting the requested file from the archive file; and
means for returning the requested file.

22. The apparatus of claim 21, further comprising:
means for determining whether the requested file in archive storage is a candidate for unarchiving based on access information;
means for unarchiving the requested file from archive storage; and
means for restoring the requested file to content storage.

23. The apparatus of claim 16, further comprising:
means for identifying one or more archived files in archive storage that are candidates for unarchiving based on access information;
means for unarchiving the one or more archived files from archive storage; and
means for restoring the one or more archived files to content storage.

24. A computer program product, in a computer readable medium, for archive management, the computer program product comprising:
instructions for identifying one or more content files in content storage that are candidates for archiving based on access information;
instructions for archiving the one or more content files into archive storage.

25. The computer program product of claim 24, further comprising:
instructions for receiving a request for a requested file, wherein the requested file is archived within an archive file in archive storage;
instructions for identifying the archive file;
instructions for extracting the requested file from the archive file; and
instructions for returning the requested file.

26. The computer program product of claim 24, further comprising:
instructions for identifying one or more archived files in archive storage that are candidates for unarchiving based on access information;
instructions for unarchiving the one or more archived files from archive storage; and
instructions for restoring the one or more archived files to content storage.
